(19) United States
(12) Patent Application Publication
(10) Pub. No.: US 2021/0267120 A1
(43) Pub. Date: Sep. 2, 2021

(54) Stationary Fertilizer Sprayer Assembly

(71) Applicant: Terry W. Buford, Auburn, AL (US)

(72) Inventor: Terry W. Buford, Auburn, AL (US)

(21) Appl. No.: 16/802,732

(22) Filed: Feb. 27, 2020

(51) Int. Cl. A01C 23/04; B01F 5/20; B05B 7/32; B05B 7/04; B05B 15/622

(52) U.S. Cl. CPC A01C 23/042; B01F 5/20; B01F 2215/0055; B05B 7/0408; B05B 15/622; B05B 7/32

(57) ABSTRACT

A stationary fertilizer sprayer assembly for watering or fertilizing a selected area includes a container that is comprised of a fluid impermeable material to contain a fluid fertilizer. A base is coupled to the container and the base rests on a support surface adjacent to an area to be fertilized. A dispensing nozzle is removably coupled to the container such that the dispensing nozzle is in fluid communication with the container and the dispensing nozzle is fluidly attachable to a water source to receive water. The dispensing nozzle includes a mixture valve that is positionable in a mixing position of a non-mixing position. In this way the dispensing nozzle can spray either pure water or a mixture of the fluid fertilizer and water.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to sprayer devices and more particularly pertains to a new sprayer device for watering or fertilizing a selected area.

### (2) Description of Related Art Including Information Disclosed Under 37 CFR 1.97 and 1.9

The prior art relates to sprayer devices. The prior art discloses a fluid metering device that includes a fluid reservoir and a tube extending through the fluid reservoir for mixing a fluid contained in the fluid reservoir with water for the purposes of irrigation. The prior art discloses a container with an inlet and an outlet that is fluidly coupled in-line with an irrigation hose thereby facilitating contents of the container to be mixed with water for irrigation. The prior art discloses a variety of fertilizer reservoirs that have a mixture tube for mixing a solution contained in the fertilizer reservoirs with water from a water source for irrigation.

### BRIEF SUMMARY OF THE INVENTION

An embodiment of the disclosure meets the needs presented above by generally comprising a container that is comprised of a fluid impermeable material to contain a fluid fertilizer. A base is coupled to the container and the base rests on a support surface adjacent to an area to be fertilized. A dispensing nozzle is removably coupled to the container such that the dispensing nozzle is in fluid communication with the container and the dispensing nozzle is fluidly attachable to a water source to receive water. The dispensing nozzle includes a mixture valve that is positionable in a mixing position of a non-mixing position. In this way the dispensing nozzle can spray either pure water or a mixture of the fluid fertilizer and water.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective in-use view of a stationary fertilizer sprayer assembly according to an embodiment of the disclosure.

FIG. 2 is a right side phantom view of an embodiment of the disclosure.

FIG. 3 is a front view of an embodiment of the disclosure.

FIG. 4 is a back view of an embodiment of the disclosure.

FIG. 5 is a top view of an embodiment of the disclosure.

FIG. 6 is a bottom view of an embodiment of the disclosure.

### DETAILED DESCRIPTION OF THE INVENTION

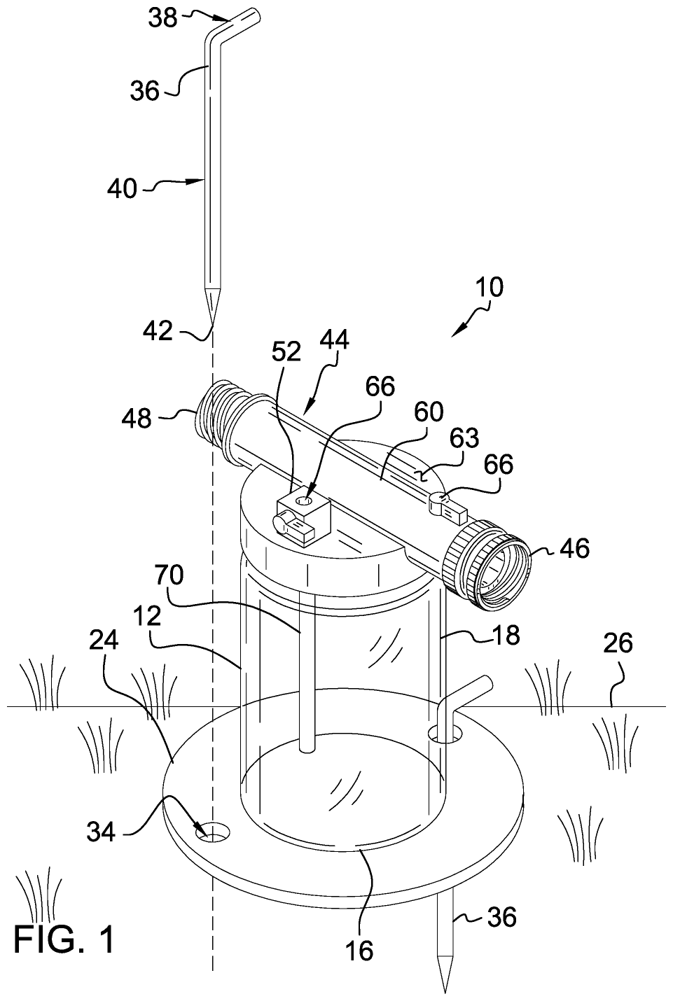

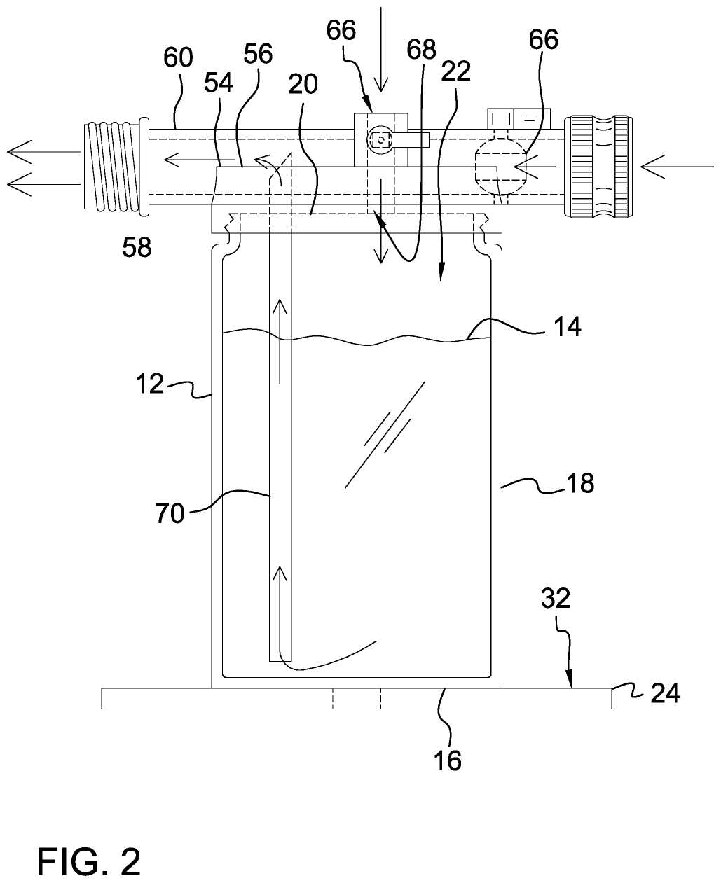

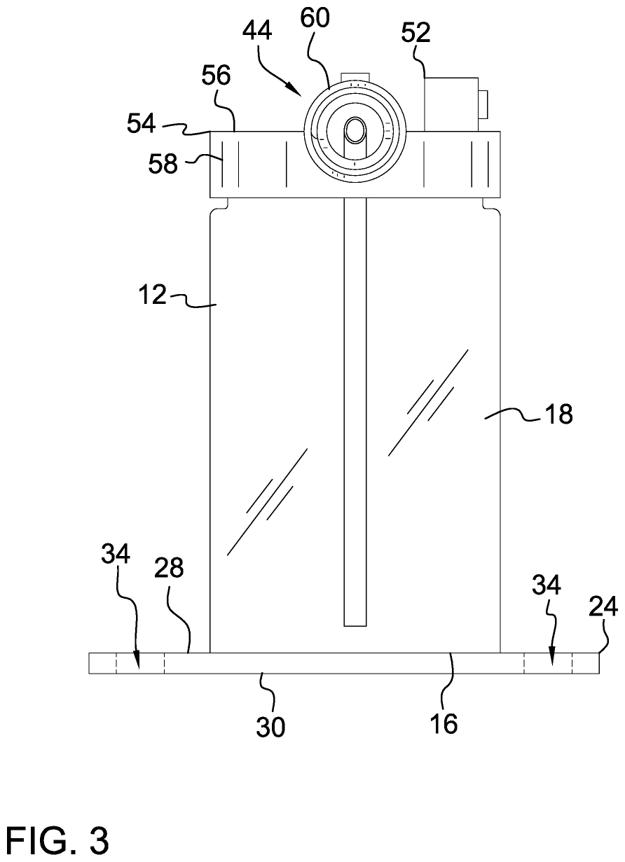

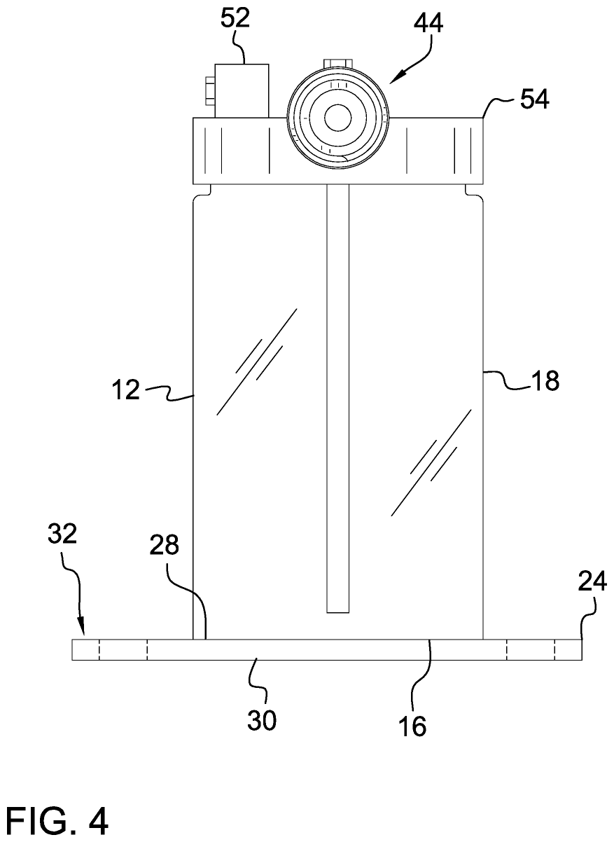

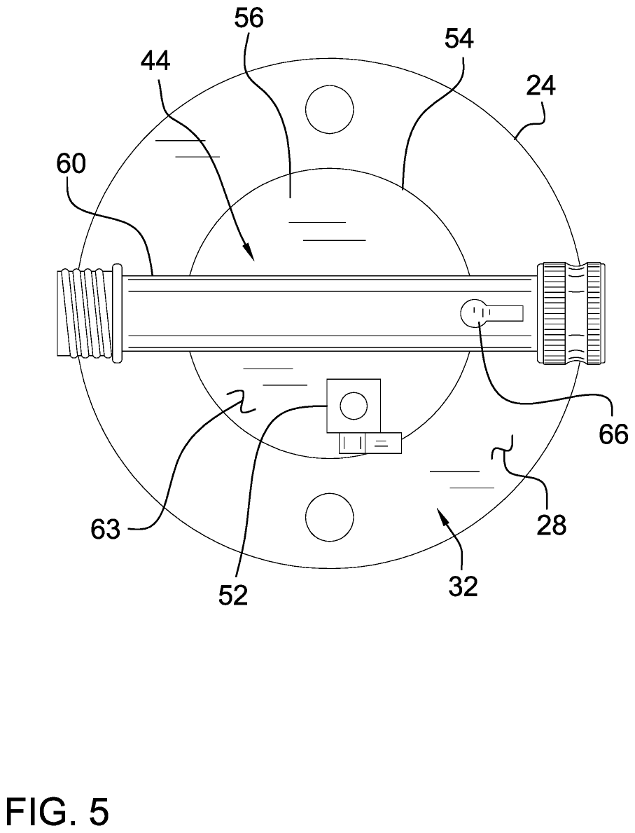

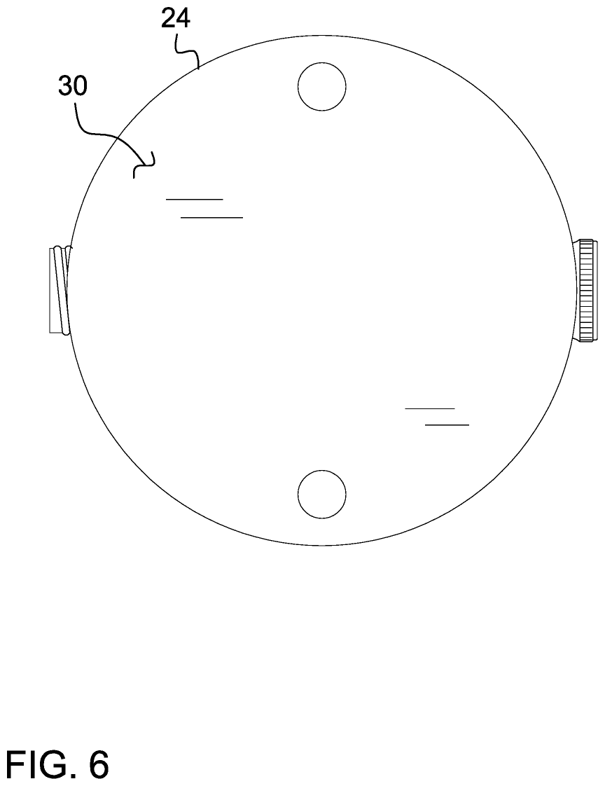

With reference now to the drawings, and in particular to FIGS. 1 through 6 thereof, a new sprayer device embodying the principles and concepts of an embodiment of the disclosure and generally designated by the reference numeral 10 will be described.

As best illustrated in FIGS. 1 through 6, the stationary fertilizer sprayer assembly 10 generally comprises a container 12 that is comprised of a fluid impermeable material for containing a fluid fertilizer 14. The container 12 may be a glass jar or other similar type of container 12. The fluid fertilizer 14 may be a fluid fertilizer of any conventional design that is applied to agricultural plants. The container 12 has a bottom wall 16 and an outer wall 18 extending upwardly from a perimeter of the bottom wall 16. The outer wall 18 has a distal edge 20 with respect to the bottom wall 16 to define an opening 22 into an interior of the container 12 and the outer wall 18 is threaded adjacent to the distal edge 20.

A base 24 is coupled to the container 12 such that the base 24 rests on a support surface 26 adjacent to an area to be fertilized. The area to be fertilized may be a vegetable garden, a flower bed, a lawn or any other area supporting cultivated plants and the support surface 26 may be ground or any other penetrable support surface. The base 24 has a top surface 28 and a bottom surface 30, and the top surface 28 is attached to the bottom wall 16 of the container 12. The base 24 has a diameter that is greater than the diameter of the container 12 to define an exposed portion 32 of the top surface 28. The base 24 has a plurality of apertures 34 each extending through the top surface 28 and the bottom surface 30, and each of the apertures 34 is positioned on the exposed portion 32.

A plurality of spikes 36 is provided and each of the spikes 36 is extendable through the base 24 to engage the support surface 26. In this way the plurality of spikes 36 can inhibit the container 12 from being displaced on the support surface 26. Each of the spikes 36 has a first portion 38 that is oriented at an angle with a second portion 40. The second portion 40 has a distal end 42 with respect to the first portion 38 and the distal end 42 tapers to a point to penetrate the support surface 26. The second portion 40 of each of the spikes 36 is extendable through a respective one of the apertures 34 in the base 24 having the first portion 38 of each of the spikes 36 resting upon the top surface 28. In this way the base 24 is inhibited from being lifted from the support surface 26.

A dispensing nozzle 44 is provided and the dispensing nozzle 44 is removably coupled to the container 12 such that the dispensing nozzle 44 is in fluid communication with the container 12. The dispensing nozzle 44 has an input 46 and an output 48, and the input 46 is fluidly attachable to a water source 50 to receive the water. The water source 50 may comprise a garden hose or a water spigot. Additionally, the input 46 may comprise a female hose coupling and the output 48 may comprise a male hose coupling. The output 48 may be fluidly coupled to a spraying hose, a supply hose of an irrigator or any other device for spraying a liquid over an agricultural area.

The dispensing nozzle 44 includes a mixture valve 52 and the mixture valve 52 is positioned between the input 46 and the output 48. The mixture valve 52 is positionable in a mixing position to pass air into the container 12. The mixture valve 52 is positionable in a non-mixing position for inhibiting the air entering the container 12. The mixture valve 52 may be a fluid valve of any conventional design that includes an engagement, such as a lever, that can be manipulated to move the mixture valve 52 between the mixing position and the non-mixing position.

The dispensing nozzle 44 comprises a lid 54 that has a top wall 56 and an exterior wall 58 extending downwardly from a perimeter of the top wall 56. The exterior wall 58 threadably engages the outer wall 18 of the container 12 having the top wall 56 resting on the distal edge 20 of the container 12. The dispensing nozzle 44 includes a tube 60 having each of the input 46 and the output 48 being associated therewith. The tube 60 has an outer wall 62 extending between the input 46 and the output 48, and the outer wall 62 of the tube 60 is coupled to a top surface 63 of the top wall 56 of the lid 54.

A shut off valve 64 is provided and the shut off valve 64 is movably integrated into the tube 60. The shut off valve 64 is positionable between an open position and an off position, and the shut off valve 64 is positioned adjacent to the input 46. The shut off valve 64 inhibits the water from passing therethrough when the shut off valve 64 is in the closed position to inhibit the water from passing outwardly through the output 48. Conversely, the shut off valve 64 facilitates the water to pass therethrough when the shut off valve 64 is in the open position to facilitate the water to pass through the tube 60. In this way either pure water can be sprayed or the mixture of water and fluid fertilizer 14 can be sprayed. The shut off valve 64 may comprise a ball valve or other similar type of fluid valve that includes an engagement, such as a lever, that can be manipulated to move the shut off valve 64 between the open position and the closed position.

The mixture valve 52 is coupled to the top surface 63 of the top wall 56 of the lid 54 and the mixture valve 52 is positioned adjacent to the outer wall 18 of the tube 60. The mixture valve 52 has an inlet portion 66 and an outlet portion 68. The inlet portion 66 is exposed to ambient air and the output portion 68 extends through the top wall 56 of the lid 54 such that the output portion 68 is in fluid communication with the container 12 when the lid 54 is coupled to the container 12. In this way the mixture valve 52 facilitates air to enter the container 12 when the mixture valve 52 is in the mixing position. Conversely, the mixture valve 52 inhibits the air from entering the container 12 when the mixture valve 52 is in the non-mixing position.

The dispensing nozzle 44 includes a mixture pipe 70 that is fluid coupled to the lid 54. The mixture pipe 70 extends upwardly into an interior of the tube 60 and downwardly into the container 12 when the lid 54 is coupled to the container 12. The mixture pipe 70 is positioned between the mixture valve 52 and the output 48 of the tube 60 to pass the mixture of water and fluid fertilizer 14 into the tube 60 for spraying the mixture. A top end 72 of the mixture pipe 70 is cut at an angle and the top end 72 of the mixture pipe 70 is positioned inside the tube 60. Thus, the water passing across the top end 72 of the mixture pipe 70 induces a suction to draw the liquid fertilizer 14 upwardly through the mixture pipe 70. The mixing valve 52 completes the circuit for air flow when the mixture valve 52 is in the mixing position to facilitate the liquid fertilizer 14 to rise through the mixture pipe 70 and mix with the water.

In use, the fluid fertilizer 14 is poured into the container 12 and the lid 54 is threaded onto the container 12. The fluid source is fluidly coupled to the input 46 of the dispensing nozzle 44 and the container 12 is placed at a selected location on the ground. Each of the spikes 36 is pushed through the respective aperture in the base 24 to retain the container 12 at the selected location. The shut off valve 64 is positioned in the open position and the mixture valve 52 is positioned in the mixing position to spray the mixture of water and fluid fertilizer 14. In this way a vegetable garden, for example, can be fertilized and watered without requiring a user to direct the spray. The shut off valve 64 is positioned in the open position and the mixture valve 52 is positioned in the non-mixing position to spray only the water.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A stationary fertilizer sprayer assembly being configured to spray a fluid fertilizer over a broad area without being held by a user, said assembly comprising:
a container being comprised of a fluid impermeable material wherein said container is configured to contain a fluid fertilizer;
a base being coupled to said container wherein said base is configured to rest on a support surface adjacent to an area to be fertilized;
a plurality of spikes, each of said spikes being extendable through said base to engage the support surface wherein said plurality of spikes is configured to inhibit said container from being displaced on the support surface; and
a dispensing nozzle being removably coupled to said container such that said dispensing nozzle is in fluid communication with said container, said dispensing nozzle having a input and an output, said input being fluidly attachable to a water source wherein said dispensing nozzle is configured to receive the water, said dispensing nozzle including a mixture valve, said mixture valve being positioned between said input and said output, said mixture valve being positionable in a mixing position for passing air into said container wherein said dispensing nozzle is configured to spray a mixture of the water and the liquid fertilizer, said mixture valve being positionable in an non-mixing position for inhibiting the air from entering said container wherein said dispensing nozzle is configured to spray only water.

2. The assembly according to claim 1, wherein said container has a bottom wall and an outer wall extending upwardly from a perimeter of said bottom wall, said outer wall having a distal edge with respect to said bottom wall to define an opening into an interior of said container, said outer wall being threaded adjacent to said distal edge.

3. The assembly according to claim 2, wherein said base has a top surface and a bottom surface, said top surface being attached to said bottom wall of said container, said base having a diameter being greater than the diameter of said container to define an exposed portion of said top surface, said base having a plurality of apertures each extending through said top surface and said bottom surface, each of said apertures being positioned on said exposed portion.

4. The assembly according to claim 3, wherein each of said spikes has a first portion being oriented at an angle with a second portion, said second portion having a distal end with respect to said first portion, said distal end tapering to a point wherein said distal end is configured to penetrate the support surface, said second portion of each of said spikes being extendable through a respective one of said apertures in said base having said first portion of each of said spikes resting upon said top surface to inhibit said base from being lifted from the support surface.

5. The assembly according to claim 1, wherein said dispensing nozzle comprises a lid having a top wall and an exterior wall extending downwardly from a perimeter of said top wall, said exterior wall threadably engaging an outer wall of said container having said top wall resting on a distal edge of said container.

6. The assembly according to claim 5, wherein said dispensing nozzle includes a tube having each of said input and said output being associated therewith, said tube having an outer wall extending between said input and said output, said outer wall of said tube being coupled to a top surface of said top wall of said lid.

7. The assembly according to claim 6, wherein said dispensing nozzle comprises a shut off valve being movably integrated into said tube, said shut off valve being positionable between an open position and an off position, said shut off valve being positioned adjacent to said input, said shut off valve inhibiting the water from passing therethrough when said shut off valve is in said closed position wherein said shut off valve is configured to inhibit the water from passing outwardly through said output, said shut off valve facilitating the water to pass therethrough when said shut off valve is in said open position wherein said shut off valve is configured to facilitate the water to pass through said tube.

8. The assembly according to claim 6, wherein said mixture valve is coupled to said top side of said top wall of said lid having said mixture valve being positioned adjacent to said outer wall of said tube, said mixture valve having an inlet portion and an outlet portion, said outlet portion being in fluid communication with an interior of said container, said input portion being exposed to ambient air.

9. The assembly according to claim 8, wherein:
said mixture valve passes air into said container when said mixture valve is positioned in said mixing position; and
said mixture valve inhibits the air from entering said container when said mixture valve is in said non-mixing position.

10. The assembly according to claim 6, further comprising a mixture pipe being fluid coupled to said lid, said mixture pipe extending upwardly into an interior of said tube and downwardly into said container when said lid is coupled to said container, said mixture pipe being positioned between said mixture valve and said output of said tube wherein said mixture pipe is configured to pass the fluid fertilizer into said tube for spraying the mixture of fluid fertilizer and water.

11. A stationary fertilizer sprayer assembly being configured to spray a fluid fertilizer over a broad area without being held by a user, said assembly comprising:
a container being comprised of a fluid impermeable material wherein said container is configured to contain a fluid fertilizer, said container having a bottom wall and an outer wall extending upwardly from a perimeter of said bottom wall, said outer wall having a distal edge with respect to said bottom wall to define an opening into an interior of said container, said outer wall being threaded adjacent to said distal edge;
a base being coupled to said container wherein said base is configured to rest on a support surface adjacent to an area to be fertilized, said base having a top surface and a bottom surface, said top surface being attached to said bottom wall of said container, said base having a diameter being greater than the diameter of said container to define an exposed portion of said top surface, said base having a plurality of apertures each extending through said top surface and said bottom surface, each of said apertures being positioned on said exposed portion;
a plurality of spikes, each of said spikes being extendable through said base to engage the support surface wherein said plurality of spikes is configured to inhibit said container from being displaced on the support surface, each of said spikes having a first portion being oriented at an angle with a second portion, said second portion having a distal end with respect to said first portion, said distal end tapering to a point wherein said distal end is configured to penetrate the support surface, said second portion of each of said spikes being extendable through a respective one of said apertures in said base having said first portion of each of said spikes resting upon said top surface to inhibit said base from being lifted from the support surface; and
a dispensing nozzle being removably coupled to said container such that said dispensing nozzle is in fluid communication with said container, said dispensing nozzle having a input and an output, said input being fluidly attachable to a water source wherein said dispensing nozzle is configured to receive the water, said dispensing nozzle including a mixture valve, said mixture valve being positioned between said input and said output, said mixture valve being positionable in a mixing position for passing air into said container wherein said dispensing nozzle is configured to spray a mixture of the water and the liquid fertilizer, said mixture valve being positionable in an non-mixing position for inhibiting the air from entering said container wherein said dispensing nozzle is configured to spray only water, said dispensing nozzle comprising:
a lid having a top wall and an exterior wall extending downwardly from a perimeter of said top wall, said exterior wall threadably engaging said outer wall of said container having said top wall resting on said distal edge of said container;
a tube having each of said input and said output being associated therewith, said tube having an outer wall extending between said input and said output, said outer wall of said tube being coupled to a top surface of said top wall of said lid;
a shut off valve being movably integrated into said tube, said shut off valve being positionable between an open position and an off position, said shut off valve being positioned adjacent to said input, said shut off valve inhibiting the water from passing therethrough when said shut off valve is in said closed position wherein said shut off valve is configured to inhibit the water from passing outwardly through said output, said shut off valve facilitating the water to pass therethrough when said shut off valve is in said open position wherein said shut off valve is configured to facilitate the water to pass through said tube;
wherein said mixture valve is coupled to said top side of said top wall of said lid having said mixture valve being positioned adjacent to said outer wall of said tube, said mixture valve having an inlet portion and an outlet portion, said outlet portion being in fluid communication with an interior of said container, said input portion being exposed to ambient air, said mixture valve passing air into said container when said mixture valve is positioned in said mixing position, said mixture valve inhibiting the air from entering said container when said mixture valve is in said non-mixing position; and
a mixture pipe being fluid coupled to said lid, said mixture pipe extending upwardly into an interior of said tube and downwardly into said container when said lid is coupled to said container, said mixture having suction being induced therein by water passing across said mixture pipe, said mixture pipe being positioned between said mixture valve and said output of said tube wherein said mixture pipe is configured to pass the fluid fertilizer into said tube for spraying the mixture of fluid fertilizer and water, the water passing across said mixture pipe induces a suction to draw the liquid fertilizer upwardly through said mixture pipe, said mixing valve completing the circuit for air flow when said mixture valve is in the mixing position to facilitate the liquid fertilizer to rise through the mixture pipe and mix with the water.
